(19) United States
(12) Patent Application Publication
(10) Pub. No.: US 2026/0279196 A1
(43) Pub. Date: Sep. 17, 2026

(54) INTERNET OF THINGS (IOT) SYSTEMS, METHODS, AND STORAGE MEDIA FOR SMART CITY OVERHEIGHT AND OVERLOAD EMERGENCY EARLY WARNING

(71) Applicant: CHENGDU QINCHUAN IOT TECHNOLOGY CO., LTD., Chengdu (CN)

(72) Inventors: Hanshu SHAO, Chengdu (CN); Xiaojun WEI, Chengdu (CN); Guobin LUO, Chengdu (CN)

(73) Assignee: CHENGDU QINCHUAN IOT TECHNOLOGY CO., LTD., Chengdu (CN)

(21) Appl. No.: 19/672,556

(22) Filed: May 8, 2026

(30) Foreign Application Priority Data
Apr. 20, 2026 (CN) 202610518724.8

(51) Int. Cl. G08G 1/07; G08G 1/01; G08G 1/017; G08G 1/052

(52) U.S. Cl. CPC G08G 1/07; G08G 1/0108; G08G 1/0129; G08G 1/0133; G08G 1/0145; G08G 1/017; G08G 1/052

(57) ABSTRACT

A method, an IoT system, and a storage medium for smart city overheight and overload emergency early warning are provided. The method includes: obtaining vehicle sensing data of an upstream road section of a target road section; determining a risk vehicle; and in response to an estimated arrival time of the risk vehicle at the target road section satisfying a preset condition: predicting a time at which the risk vehicle arrives at a target traffic signal light; determining a first control parameter, which includes a start time at which the target traffic signal light is switched to a target state; sending a first control instruction to the target traffic signal light; and controlling the target traffic signal light to trigger a sub-clock at the start time, and controlling a relay group to switch on a first lamp bead unit, to drive the first lamp bead unit to emit light.

### CROSS-REFERENCE TO RELATED APPLICATIONS

This application claims priority to Chinese Patent Application No. 202610518724.8, filed on Apr. 20, 2026, the entire contents of which are hereby incorporated by reference.

### TECHNICAL FIELD

The present disclosure relates to the field of overheight and overload supervision for urban road vehicles, and in particular relates to an Internet of Things (IoT) system, a method, and a storage medium for smart city overheight and overload emergency early warning.

### BACKGROUND

In urban traffic, infrastructures such as bridges, viaducts, and roadways are subject to corresponding height and load limit standards. Vehicles exceeding the height and/or load limit standards may cause impact damage to bridges, viaducts, and roadways, which not only increases road administration and maintenance costs, but also leads to potential safety hazards.

Therefore, there is an urgent need to provide an IoT system, a method, and a storage medium for smart city overheight and overload emergency early warning, which are capable of performing overheight and overload detection on vehicles operating in urban traffic, performing risk assessment based on detection results, sending warning information to risk vehicles and traffic management authorities, and simultaneously controlling interconnected devices in urban traffic to perform risk avoidance operations according to risk assessment results.

### SUMMARY

One or more embodiments of the present disclosure provide an Internet of Things (IoT) system for smart city overheight and overload emergency early warning, comprising an emergency supervision management platform. The emergency supervision management platform is configured to: obtain vehicle sensing data of an upstream road section of a target road section, the target road section being an overheight and overloaded road section; determine a risk vehicle based on the vehicle sensing data; and in response to an estimated arrival time of the risk vehicle at the target road section satisfying a preset condition, perform traffic signal light control. To perform the traffic signal light control, the emergency supervision management platform is further configured to: predict a time at which the risk vehicle arrives at a target traffic signal light; determine a first control parameter based on the time at which the risk vehicle arrives at the target traffic signal light, wherein the first control parameter includes a start time at which the target traffic signal light is switched to a target state; send a first control instruction to the target traffic signal light based on the first control parameter; and control, based on the first control instruction, the target traffic signal light to trigger a sub-clock at the start time, and control a relay group to conduct a first lamp bead unit, so as to drive the first lamp bead unit to emit light.

One or more embodiments of the present disclosure provide a method for smart city overheight and overload emergency early warning, being implemented by an emergency supervision management platform. The method comprises: obtaining vehicle sensing data of an upstream road section of a target road section, the target road section being an overheight and overloaded road section; determining a risk vehicle based on the vehicle sensing data; and in response to an estimated arrival time of the risk vehicle at the target road section satisfying a preset condition, performing traffic signal light control, including: predicting a time at which the risk vehicle arrives at a target traffic signal light; determining a first control parameter based on the time at which the risk vehicle arrives at the target traffic signal light, wherein the first control parameter includes a start time at which the target traffic signal light is switched to a target state; sending a first control instruction to the target traffic signal light based on the first control parameter; and controlling, based on the first control instruction, the target traffic signal light to trigger a sub-clock at the start time, and controlling a relay group to switch on a first lamp bead unit, so as to drive the first lamp bead unit to emit light.

One or more embodiments of the present disclosure provide a non-transitory computer-readable storage medium. The storage medium stores computer instructions that, when read by a computer, cause the computer to execute the method for smart city overheight and overload emergency early warning according to any one or more of the embodiments of the present disclosure.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is an exemplary schematic diagram of an IoT system for smart city overheight and overload emergency early warning according to some embodiments of the present disclosure.

FIG. 2 is a flowchart of an exemplary process of a method for smart city overheight and overload emergency early warning according to some embodiments of the present disclosure.

FIG. 3 is a flowchart of an exemplary process for determining an estimated arrival time according to some embodiments of the present disclosure.

FIG. 4 is an exemplary schematic diagram of response behavior monitoring according to some embodiments of the present disclosure.

FIG. 5 is an exemplary schematic diagram of a road network according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used herein, is merely a way of describing the associative relationship of an associated object, indicating that three relationships may exist, e.g., A and/or B, which may be represented as: A alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Furthermore, if the description of the embodiments in the present disclosure involves descriptions such as “first” and “second,” then these descriptions are for descriptive purposes only and are not to be construed as indicating or implying relative importance or implicitly specifying the quantity of the indicated technical features. Thus, features defined by “first” or “second” may explicitly or implicitly include at least one such feature.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

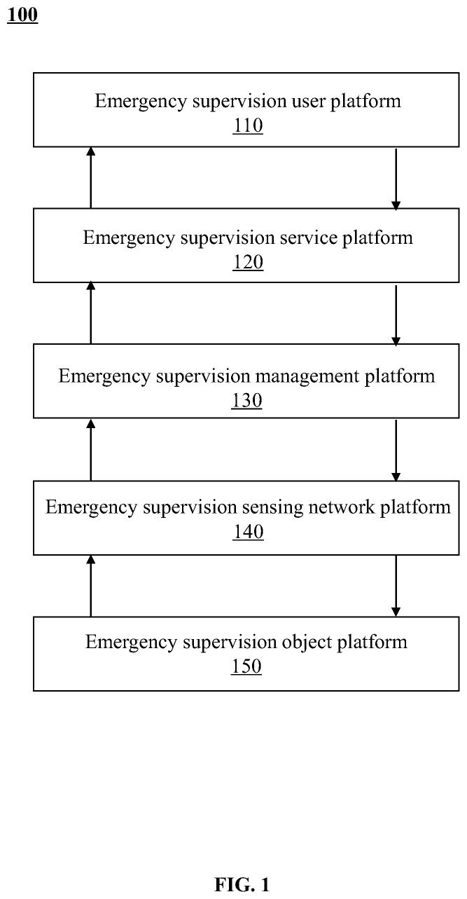

FIG. 1 is an exemplary schematic diagram of an IoT system for smart city overheight and overload emergency early warning according to some embodiments of the present disclosure. It should be noted that the following embodiments are provided merely for explaining the present disclosure and do not constitute any limitation on the present disclosure.

In some embodiments, as shown in FIG. 1, an IoT system 100 for smart city overheight and overload emergency early warning (hereinafter also referred to as the IoT system 100, or the system) may include an emergency supervision user platform 110, an emergency supervision service platform 120, an emergency supervision management platform 130, an emergency supervision sensing network platform 140, and an emergency supervision object platform 150.

In some embodiments, one or more platforms in the IoT system 100 may exchange information and/or data with each other via a network. In some embodiments, the network may be any one or a combination of a wired network and a wireless network.

The emergency supervision user platform 110 refers to a platform on which a supervision user obtains supervision information and deploy supervision decisions. The supervision user may include personnel of traffic safety management authorities, or the like. In some embodiments, the emergency supervision user platform 110 may include at least one human-machine interaction device, such as a mobile phone, a computer, or the like.

The emergency supervision service platform 120 refers to a platform for receiving and transmitting data and/or information. In some embodiments, the emergency supervision service platform 120 may be configured as a communication network, a gateway, or the like. In some embodiments, the emergency supervision service platform 120 may perform bidirectional data interaction with the emergency supervision user platform 110 and the emergency supervision management platform 130.

The emergency supervision management platform 130 is a comprehensive management platform for centralized management, coordination, and collaboration among multiple platforms. The emergency supervision management platform 130 may be configured as a server or a processor. In some embodiments, the emergency supervision management platform 130 is communicatively connected to the emergency supervision object platform 150 via the emergency supervision sensing network platform 140.

In some embodiments, the emergency supervision management platform 130 is configured to: obtain vehicle sensing data of an upstream road section of a target road section; determine a risk vehicle based on the vehicle sensing data; and in response to an estimated arrival time of the risk vehicle at the target road section satisfying a preset condition, perform traffic signal light control, including: predicting a time at which the risk vehicle arrives at a target traffic signal light; determining a first control parameter based on the time at which the risk vehicle arrives at the target traffic signal light; sending a first control instruction to the target traffic signal light based on the first control parameter; and controlling, based on the first control instruction, the target traffic signal light to trigger a sub-clock at a start time, and controlling a relay group to conduct a first lamp bead unit, so as to drive the first lamp bead unit to emit light.

The emergency supervision sensing network platform 140 is configured to comprehensively manage sensing information, and serves as a communication transmission platform for implementing bidirectional data interaction between the emergency supervision management platform 130 and the emergency supervision object platform 150. In some embodiments, the emergency supervision sensing network platform 140 may be configured as a communication network, a gateway, or the like. The emergency supervision sensing network platform 140 is responsible for uploading real-time sensing data collected by the emergency supervision object platform 150 to the emergency supervision management platform 130, and delivering a regulation and control instruction generated by the emergency supervision management platform 130 to the corresponding emergency supervision object platform 150 for execution.

The emergency supervision object platform 150 is a platform for generating supervision information and executing control instructions. In some embodiments, the emergency supervision object platform 150 may include a plurality of monitoring, sensing, and interaction devices deployed along urban traffic roadways and at road intersections, such as roadside radars, traffic indication signs, electronic display screens, laser height measuring devices, road weighing systems, intelligent cameras, on-board vision systems, signal controllers, or the like.

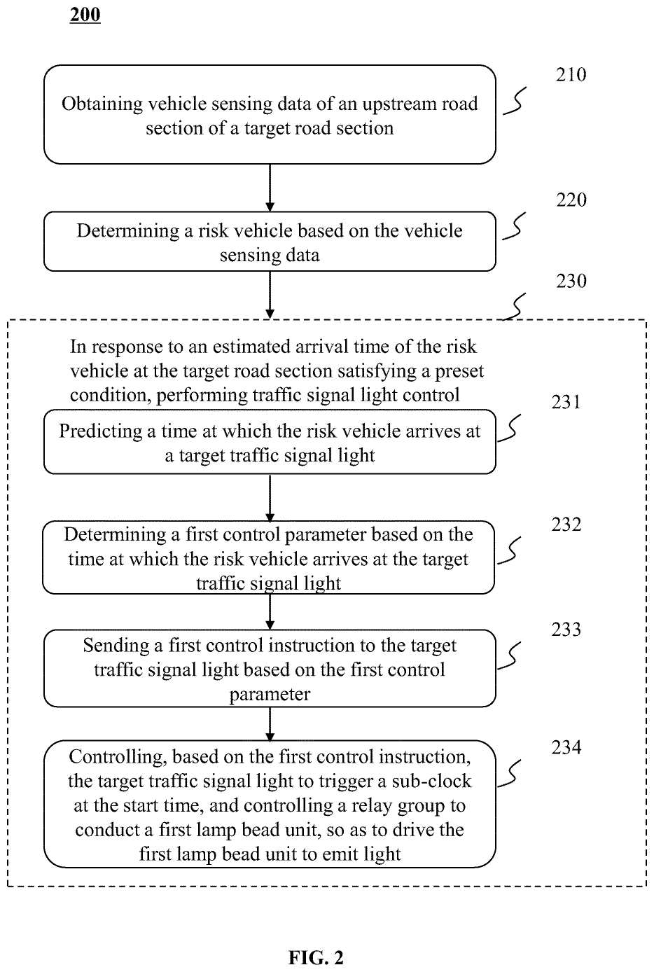

For more details regarding the above platforms, reference may be made to FIGS. 2 to 4 and the related descriptions thereof.

In the IoT system 100, the functional platforms may be communicatively connected with each other, such that an information operation closed loop is formed among the functional platforms. Under unified management of the emergency supervision management platform 130, the functional platforms operate in a coordinated and orderly manner, thereby realizing information-based and intelligent emergency early warning for vehicle overheight and overload supervision.

It should be noted that the above description of the IoT system 100 is provided merely for convenience of explanation, and does not limit the present disclosure to the scope of the illustrated embodiments.

FIG. 2 is a flowchart of an exemplary process of a method for smart city overheight and overload emergency early warning according to some embodiments of the present disclosure. As shown in FIG. 2, a process 200 includes the following steps 210 to 230. In some embodiments, the process 200 may be executed by an emergency supervision management platform (e.g., the emergency supervision management platform 130).

Step 210: obtaining vehicle sensing data of an upstream road section of a target road section.

The target road section refers to a vulnerable road section in a highway or an urban road that requires protective measures due to structural characteristics or load-bearing limitations, for example, a bridge, a tunnel, a culvert, or the like. In some embodiments, the target road section is an overheight and overloaded road section.

The overheight and overloaded road section refers to a road section on which passage restrictions related to vehicle height and load are imposed in order to ensure operational safety of road facilities such as bridges, tunnels, and culverts, and to prevent structural damage or safety accidents caused by vehicles traveling with excessive height or load. For example, the road section may restrict a vehicle height to be lower than a height threshold, and restrict a total weight of a vehicle and its carried load (collectively referred to as a vehicle weight) to be lower than a weight threshold. The height threshold and the weight threshold may be preset based on actual supervision requirements, road design standards, and historical operation experience, through manual configuration or expert experience.

The upstream road section of the target road section refers to a road section that is adjacent to an entrance end of the target road section in a vehicle traveling direction, and that the vehicle must pass before entering the target road section.

The vehicle sensing data refers to data related to physical states, dynamic characteristics, and basic attributes of a vehicle. For example, the vehicle sensing data may include the vehicle weight, the vehicle height, vehicle identification information, and a vehicle speed. The vehicle identification information refers to information that uniquely identifies and distinguishes a vehicle entity, such as a license plate number, a vehicle identification number, or the like.

In some embodiments, the vehicle sensing data may be acquired by various types of sensing devices. Exemplary sensing devices may include a dynamic weighing sensor, a laser height measuring device, a structured light scanner, a monitoring camera, or the like. For example, a dynamic weighing sensor may be deployed on a road surface of the upstream road section, such that the vehicle weight is measured when a vehicle passes thereover. The vehicle height may be obtained by performing three-dimensional profile scanning using a laser height measuring device or a structured light scanner deployed along a roadside. The vehicle identification information may be obtained by identifying a license plate number or the like through a monitoring camera. For more details regarding the sensing devices, reference may be made to the corresponding description of the emergency supervision object platform in FIG. 1.

Step 220: determining a risk vehicle based on the vehicle sensing data.

The risk vehicle refers to a vehicle having an over-height condition or an overload condition.

In some embodiments, the emergency supervision management platform may determine the risk vehicle based on the vehicle sensing data. For example, when the vehicle height is greater than the height threshold, the vehicle is determined to have an over-height condition; and when the vehicle weight is greater than the weight threshold, the vehicle is determined to have an overload condition.

Step 230: in response to an estimated arrival time of the risk vehicle at the target road section satisfying a preset condition, performing traffic signal light control.

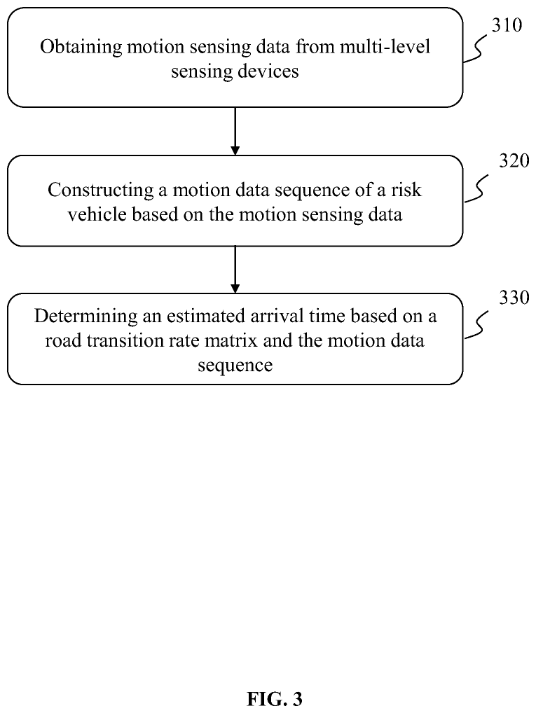

The estimated arrival time refers to an estimated time at which the risk vehicle arrives at the target road section. In some embodiments, the emergency supervision management platform may calculate the estimated arrival time based on a current position, the vehicle speed, and a remaining distance to the target road section of the risk vehicle. For more details regarding determination of the estimated arrival time, reference may be made to FIG. 3 and the related descriptions thereof.

The preset condition refers to a triggering condition used by the emergency supervision management platform to determine whether traffic signal light control is to be performed. In some embodiments, the preset condition may include that the estimated arrival time is less than a time threshold, wherein the time threshold may be set based on experience of those skilled in the art.

The traffic signal light control refers to an operation in which, in response to the preset condition being satisfied, the emergency supervision management platform performs strategic adjustment and intervention on traffic signal lights of the target road section and/or upstream associated intersections.

In some embodiments, the traffic signal light control may be performed periodically based on a preset cycle. The preset cycle may be a preset duration such as 30 seconds.

In some embodiments, the traffic signal light control includes sub-steps 231 to 234. The sub-steps 231 to 234 may be executed by the emergency supervision management platform.

Step 231: predicting a time at which the risk vehicle arrives at a target traffic signal light.

The target traffic signal light refers to a first traffic signal light that is located downstream of a current position of the risk vehicle, lies along a traveling path and a traveling direction of the risk vehicle, and is closest to the current position of the risk vehicle. In some embodiments, the target traffic signal light may be dynamically updated according to a real-time position and a traveling direction of the risk vehicle.

The time at which the risk vehicle arrives at the target traffic signal light refers to a predicted time at which the risk vehicle is expected to arrive at the current target traffic signal light.

In some embodiments, the emergency supervision management platform may estimate the time at which the risk vehicle arrives at the target traffic signal light based on the current position and the vehicle speed of the risk vehicle, and a geographical location of the target traffic signal light.

Step 232: determining a first control parameter based on the time at which the risk vehicle arrives at the target traffic signal light.

The first control parameter refers to a parameter for regulating a display state of the target traffic signal light. In some embodiments, the first control parameter includes a start time at which the target traffic signal light is switched to a target state. The target state may be a state in which the target traffic signal light maintains a red-light display.

In some embodiments, the emergency supervision management platform may determine the first control parameter based on the time at which the risk vehicle arrives at the target traffic signal light in various manners. In some embodiments, the start time at which the target traffic signal light is switched to the target state in the first control parameter may be set to a sum of a predicted time at which the risk vehicle arrives at the target traffic signal light and a safety margin. The safety margin is used to compensate for possible delays occurring during prediction and communication processes, so as to ensure that when the risk vehicle arrives at the target traffic signal light, the target traffic signal light is in the red-light state. The safety margin may be preset based on experience of those skilled in the art, for example, 5 seconds.

In some embodiments, the first control parameter further includes a duration of the target state of the target traffic signal light.

In some embodiments, the emergency supervision management platform is further configured to: determine a target dwell time of the risk vehicle at the target traffic signal light; and determine the first control parameter based on the time at which the risk vehicle arrives at the target traffic signal light and the target dwell time.

The target dwell time refers to a time duration for which the emergency supervision management platform expects the risk vehicle to stop at the corresponding target traffic signal light due to a red light.

In some embodiments, the target dwell time may be set based on experience of those skilled in the art.

In some embodiments, the emergency supervision management platform is further configured to determine a target time period based on a time point at which the risk vehicle is determined, and to determine the target dwell time based on, within the target time period, an accumulated travel distance of the risk vehicle traveling along an original planned route and a speed sequence of the risk vehicle.

The time point at which the risk vehicle is determined refers to a time point at which the emergency supervision management platform initially determines a vehicle as the risk vehicle based on the vehicle sensing data. In some embodiments, the time point at which the risk vehicle is determined may be obtained by querying log information in a system that records risk vehicle determination events and corresponding timestamps.

The target time period refers to a time duration from the time point at which the risk vehicle is determined to a current time point.

The accumulated travel distance of the risk vehicle traveling along an original planned route refers to a total distance traveled by the risk vehicle along the original planned route from the time point at which the risk vehicle is determined to the current time point. The original planned route refers to a travel path planned by a vehicle driver according to a travel intention thereof and including the target road section. In some embodiments, the original planned route may be obtained through an on-board navigation system.

The speed sequence of the risk vehicle refers to an ordered set of instantaneous speed values of the risk vehicle that are continuously acquired and recorded at fixed time intervals within the target time period. In some embodiments, the instantaneous speed values of the risk vehicle may be obtained in real time through on-board GPS, roadside speed detection sensors, or other positioning devices.

In some embodiments, the emergency supervision management platform may determine the target dwell time based on, within the target time period, the accumulated travel distance of the risk vehicle traveling along the original planned route and the speed sequence of the risk vehicle, by using a duration determination model.

The duration determination model refers to a model configured to determine the target dwell time. In some embodiments, the duration determination model may be a machine learning model. For example, the duration determination model may include one or more of a Recurrent Neural Network (RNN) model, a Long Short-Term Memory (LSTM) network model, or other customized models, or a combination thereof.

In some embodiments, inputs of the duration determination model may include, within the target time period, the accumulated travel distance of the risk vehicle traveling along the original planned route and the speed sequence of the risk vehicle, and an output of the duration determination model may include the target dwell time.

In some embodiments, the duration determination model may be obtained by training an initial duration determination model using multiple groups of labeled training samples. The training samples may include sample data of sample risk vehicles identified from historical data and successfully diverted. Successfully diverting a sample risk vehicle refers to preventing the sample risk vehicle from entering the target road section through traffic signal light control (for example, by increasing a red-light duration). The training samples include an accumulated travel distance of the sample risk vehicle traveling along an original planned route and a speed sequence corresponding to the sample risk vehicle. The labels may include an actual dwell time of the sample risk vehicle at a target traffic signal light corresponding to the training sample.

In some embodiments, the emergency supervision management platform may input multiple labeled training samples into the initial duration determination model, construct a loss function based on the labels and results of the initial duration determination model, and iteratively update parameters of the initial duration determination model based on the loss function by using gradient descent or other techniques. When a preset termination condition is satisfied, model training is completed, and a trained duration determination model is obtained. The preset termination condition may include convergence of the loss function, a count of iterations reaching a threshold, or the like.

In some embodiments of the present disclosure, by dynamically calculating, within the target time period, the accumulated travel distance of the risk vehicle traveling along the original planned route and the speed sequence of the risk vehicle, and adaptively determining the target dwell time, a response escalation mechanism is implemented. A higher degree of resistance of the risk vehicle to control, i.e., a longer accumulated travel distance while continuously traveling along the original planned route, corresponds to a longer red-light duration so as to enhance an obstructing effect. The response escalation mechanism overcomes a drawback that a fixed-duration control scheme may be ineffective for persistent or noncompliant vehicles, and improves adaptive handling capability of the system under complex traffic conditions and abnormal behaviors, thereby effectively forcing the risk vehicle to change a travel route and ensuring safety of the target road section.

In some embodiments, the emergency supervision management platform determines the first control parameter based on the time at which the risk vehicle arrives at the target traffic signal light and the target dwell time.

In some embodiments of the present disclosure, by introducing the target dwell time as a control parameter, the system implements fine-grained regulation of a traffic signal control strategy, abandons a coarse fixed-duration red-light control scheme, and instead dynamically calculates and generates precise control instructions based on actual obstruction requirements, thereby significantly improving targeted control, adaptability, and execution effectiveness.

Step 233: sending a first control instruction to the target traffic signal light based on the first control parameter.

The first control instruction refers to an instruction used to indicate the target traffic signal light to be activated at a specific time (i.e., the start time of the target state), to indicate that a specific direction is permitted or prohibited for traffic, and to control a maintenance duration (i.e., the duration of the target state) of the target traffic signal light. For example, the control instruction may be: “activate a northwest-direction red light at 3:40, and maintain the red light for 60 seconds.”

In some embodiments, the first control instruction is a data packet conforming to a standard traffic signal control protocol. The standard traffic signal control protocol may include NTCIP, SPaT, or the like. Merely by way of example, the first control instruction may control a first phase of the target traffic signal light, wherein the first phase controls the target traffic signal light to trigger a sub-clock at a red-light start time (i.e., the start time of the target state), and cyclically controls a relay group to conduct a red-light phase. The first control instruction may be used to prevent the risk vehicle from traveling toward the target road section.

In some embodiments, the emergency supervision management platform may send the first control instruction to the target traffic signal light via a network. For more details regarding the network, reference may be made to FIG. 1 and the related descriptions thereof.

Step 234: controlling, based on the first control instruction, the target traffic signal light to trigger a sub-clock at the start time, and controlling a relay group to conduct a first lamp bead unit, so as to drive the first lamp bead unit to emit light.

The sub-clock refers to a logical functional unit configured to generate an independent timing sequence for a single traffic signal light group and to implement phase difference control by setting a start delay.

The relay group refers to a collection of electrical switching components configured to safely drive high-power signal lamp illumination via a low-power control circuit. In some embodiments, a relay is actuated by energizing a coil to close a physical switch, thereby connecting an external high-power circuit.

The first lamp bead unit refers to an independent illumination component in the target traffic signal light that is controlled by the relay group and configured to implement a traffic indication function. In some embodiments, the first lamp bead unit may be composed of a plurality of red light-emitting diodes (LEDs).

After receiving and executing the first control instruction, the target traffic signal light can adjust a signal phase based on the first control instruction, such that when the risk vehicle arrives at the target traffic signal light, the target traffic signal light is in the red-light state, thereby obstructing the risk vehicle from continuing toward the target road section.

In some embodiments, the traffic signal light control may further include: in response to a determination that the estimated arrival time of the risk vehicle at the target road section satisfies a preset condition, sending an instruction to a navigation system of the risk vehicle, and displaying, through dynamic “virtual lane” guidance, a virtual path that the risk vehicle is required to follow, the virtual path pointing to a preset “buffer enforcement area” (such as an emergency parking lane, a service area entrance, or a specific ramp). The virtual path may be generated by using an existing route planning algorithm.

In some embodiments of the present disclosure, the method for smart city overheight and overload emergency early-warning implements active, forward-looking, and precise prevention and control of risk vehicles. By real-time sensing and identifying risk vehicles in an upstream road section, predicting a time at which the risk vehicle arrives at the target traffic signal light, and dynamically generating the first control parameter based on the time at which the risk vehicle arrives at the target traffic signal light, the traffic signal light is driven to switch to a red-light state at an accurate start time. The method advances a risk interception stage, thereby avoiding vehicle damage and traffic interruption that may be caused by passive collisions with conventional height-limiting frames, and significantly improving safety and control efficiency of overheight and overloaded road sections. Meanwhile, while obstructing risk vehicles, the method reduces negative impact on overall intersection traffic efficiency.

FIG. 3 is a flowchart of an exemplary process for determining an estimated arrival time according to some embodiments of the present disclosure. As shown in FIG. 3, a process 300 includes steps 310 to 330 described below. In some embodiments, the process 300 may be performed by an emergency supervision management platform (e.g., the emergency supervision management platform 130).

Step 310: obtaining motion sensing data from multi-level sensing devices.

The multi-level sensing devices are combinations of monitoring apparatuses configured to acquire vehicle perception data in real time. For example, the multi-level sensing devices may include surveillance cameras, LiDARs, laser scanning arrays, geomagnetic sensors, or the like. In some embodiments, the multi-level sensing devices may be classified into different levels according to their distances from a risk vehicle. In some embodiments, the closer a multi-level sensing device is to the risk vehicle, the lower the assigned level, that is to say, the smaller the corresponding level value.

The motion sensing data refers to information capable of reflecting a real-time motion state of a vehicle. For example, the motion sensing data may include a position, a speed, a heading angle, or the like, of a vehicle. In some embodiments, the motion sensing data includes positions and speeds of the risk vehicle at multiple time points.

In some embodiments, the motion sensing data may be obtained via the multi-level sensing devices. For example, precise speed and position information of the vehicle may be obtained through upstream roadside millimeter-wave radars, while surveillance cameras may continuously track the vehicle's motion trajectory and variations in heading angle.

Step 320: constructing a motion data sequence of the risk vehicle based on the motion sensing data.

The motion data sequence refers to a sequence formed by motion sensing data of the vehicle at multiple time points, arranged in chronological order according to timestamps.

In some embodiments, the motion data sequence may be constructed by real-time extraction, from the multi-level sensing devices, of an identity identifier of the risk vehicle and corresponding position and speed data under respective timestamps; subsequently arranging all data points in ascending order of timestamps to form a continuous trajectory; then cleaning and interpolating missing or abnormal values using a filtering algorithm to ensure continuity and integrity of the sequence; and finally storing the processed data in a structured form to generate an ordered data sequence including fields such as timestamps, positions, and speeds.

Step 330: determining an estimated arrival time based on a road transition rate matrix and the motion data sequence.

The road transition rate matrix refers to a sparse square matrix describing probabilities of vehicles transferring from a current road segment to downstream road segments within a road network. In some embodiments, rows of the road transition rate matrix represent road segments on which a vehicle is currently traveling, and columns represent road segments to which the vehicle may proceed. Element values of the road transition rate matrix represent traffic flow transition rates between different road segments. For example, a road transition rate di-j represents a ratio of a count of vehicles traveling from a road segment i to a road segment j to a total count of vehicles on the road segment i.

In some embodiments, a dimension of the road transition rate matrix may be determined based on a structure of the road network and dimensions of the multi-level sensing devices. The dimensions of the multi-level sensing devices refer to hierarchical ranges of road segments in a downstream road network that are required to be covered by monitoring devices for tracking the risk vehicle. In some embodiments, the dimensions of the multi-level sensing devices may be preset by those skilled in the art based on experience.

The road network refers to a traffic network composed of a series of unidirectional road segments and intersections. Within the road network, vehicles are allowed to travel only along predefined permitted driving directions, and reverse driving is prohibited. Each road segment has a unique identifier (for example, road segment 1, road segment 2), a downstream end of each road segment being connected to one or more intersections, and each intersection further extending to a plurality of new downstream road segments, thereby forming a continuous networked structure with explicit directional flow relationships.

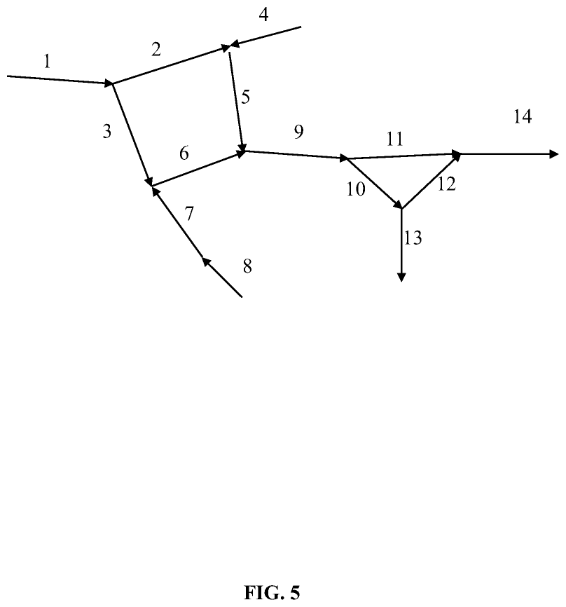

FIG. 5 is an exemplary schematic diagram of a road network according to some embodiments of the present disclosure. As shown in FIG. 5, reference numerals denote identifiers of road segments (for example, “1” represents road segment 1), and arrows indicate preset permitted traveling directions between road segments.

By way of example, the road network shown in FIG. 5 has the following structure: a downstream end of road segment 1 is connected to an intersection, and the intersection leads to road segment 2 and road segment 3; a downstream intersection of road segment 2 is connected to road segment 4 and road segment 5, but a permitted traveling direction of road segment 4 is opposite to that of road segment 2, such that vehicles on road segment 2 are unable to travel to road segment 4 and therefore can only travel toward road segment 5; a downstream intersection of road segment 3 is connected to road segment 6 and road segment 7, but a permitted traveling direction of road segment 7 is opposite to that of road segment 3, such that vehicles on road segment 3 are unable to travel to road segment 7 and therefore can only travel toward road segment 6; road segment 5 and road segment 6 both lead to road segment 9. Relationships among remaining road segments 10 to 14 are not described herein for brevity.

If a risk vehicle is initially located on road segment 1 within the road network structure, and a dimension of the multi-level sensing devices is set to 3, monitoring devices corresponding to all road segments within three downstream road-segment hierarchy levels from road segment 1 are required to be monitored. Specifically, a first-level set of road segments is {2, 3}, a second-level set of road segments is {5, 6}, and a third-level set of road segments is {9}. Accordingly, monitoring devices associated with a road-segment set S={1, 2, 3, 5, 6, 9} are to be considered, and a road transition rate matrix is obtained as a 6×6 square matrix. An element a₁₋₂ in a first row and a second column of the road transition rate matrix represents a ratio of a count of vehicles traveling from road segment 1 to road segment 2 to a total count of vehicles on road segment 1.

In some embodiments, if two road segments (for example, road segment 2 and road segment 3, or road segment 2 and road segment 6) are not mutually passable, corresponding element values in the road transition rate matrix may be assigned a value of 0. If two road segments (for example, from road segment 2 to road segment 9 via road segment 5) are not physically adjacent but are connectable through a passable path, corresponding element values in the road transition rate matrix may be assigned a value b. In some embodiments, the value b may be a preset placeholder value.

In some embodiments, the road transition rate matrix may be determined based on historical data. The road transition rate matrix may be obtained by acquiring motion trajectories of all vehicles in a road network during a historical time period as recorded in historical data, and determining vehicle transition frequencies between any two adjacent road segments through statistical analysis. For example, if a count of vehicles departing from road segment 1 within a past one-hour period is 100 and all of the 100 vehicles enter road segment 2, a road transition rate from road segment 1 to road segment 2 is 100%. As another example, if a count of vehicles departing from road segment 2 is 100 and 30 vehicles among the 100 vehicles enter road segment 5, a road transition rate from road segment 2 to road segment 5 is 30%.

For more details regarding the estimated arrival time, reference may be made to step 230 and the related descriptions thereof.

In some embodiments, the emergency supervision management platform may determine the estimated arrival time based on the road transition rate matrix and the motion data sequence through one or more approaches.

In some embodiments, the emergency supervision management platform is further configured to determine one or more potential traveling paths based on the road transition rate matrix; determine one or more historical average speeds corresponding to the potential traveling paths; and determine the estimated arrival time based on the motion data sequence and the one or more historical average speeds.

The one or more potential traveling paths refer to one or more candidate routes along which the risk vehicle may travel from a current location toward a target road segment. In some embodiments, one potential traveling path is composed of a plurality of road segments.

By way of example, as shown in FIG. 5, if the current location of the risk vehicle is road segment 1 and the target road segment is road segment 14, the one or more potential traveling paths include the following four paths: 1→2→5→9→11→14, 1→2→5→9→10→12→14, 1→3→6→9→11→14, and 1→3→6→9→10→12→14.

In some embodiments, the one or more potential traveling paths may be determined based on a road network structure and traffic rules by using a path planning algorithm. The path planning algorithm may include, but is not limited to, one or more of a Dijkstra algorithm, an A* algorithm, a rapidly-exploring random tree algorithm, and a prediction technique based on a probabilistic graphical model.

In some embodiments, the historical average speed corresponding to a potential traveling path refers to a statistically averaged traveling speed of all vehicles on the potential traveling path in historical data under scenarios matching a current time period and weather conditions.

In some embodiments, the emergency supervision management platform may construct a first preset table based on historical time periods, historical weather conditions, and historical average speeds corresponding to the potential traveling paths in historical data. The first preset table includes a correspondence relationship among historical time periods, historical weather conditions, and historical average speeds corresponding to the potential traveling paths. The emergency supervision management platform may query the first preset table to determine, based on a current time period, current weather conditions, and a current potential traveling path, a historical average speed corresponding to the potential traveling path.

In some embodiments, the emergency supervision management platform may determine the estimated arrival time based on the motion data sequence and the historical average speeds by using a fusion algorithm. In some embodiments, the fusion algorithm may include the following three steps.
Step 1: calculating a path-calibrated speed. For each potential traveling path, the speed data in the motion data sequence and the historical average speed corresponding to the potential traveling path under identical historical conditions (such as the same time period and weather conditions) are weighted and averaged to obtain a calibrated speed, which may be calculated as shown in Equation (1):

$${V}_{k} = α \cdot {V}_{current} + ( 1 - α ) \cdot {V}_{{avg \_ historical}_{k}} , \qquad ( 1 )$$

wherein, the subscript k denotes an index of a potential traveling path, where k=1, 2, 3, . . . , K, and K is a total count of the one or more potential traveling paths; a denotes a weighting factor for adjusting relative contributions of real-time information and historical information; Vₖ denotes a calibrated speed of a k-th potential traveling path; V_{current} denotes speed data in the motion data sequence; and V_{avg_historical}_{ₖ} denotes the historical average speed corresponding to the k-th potential traveling path.
Step 2: calculating an estimated travel time. In some embodiments, the emergency supervision management platform may divide a length of a potential traveling path by the corresponding calibrated speed, to obtain an estimated travel time of the vehicle on the potential traveling path. The estimated travel time may be calculated by using Equation (2):

$${T}_{k} = \frac{{L}_{k}}{{V}_{k}} , \qquad ( 2 )$$

wherein, Tₖ denotes an estimated travel time of the k-th potential traveling path, and Lk denotes a length of the k-th potential traveling path.
Step 3: weighted calculation of the estimated arrival time. In some embodiments, the emergency supervision management platform may perform a weighted summation of the estimated travel times of all potential traveling paths by using road transition rates corresponding to the potential traveling paths as weights, to obtain the estimated arrival time. The estimated arrival time may be calculated as shown in Equation (3):

$$ETA = {\sum }_{K} ( {p}_{k} \cdot {T}_{k} ) , \qquad ( 3 )$$

wherein, ETA denotes the estimated arrival time, and pₖ denotes a product obtained by successively multiplying road transition rates corresponding to each pair of physically adjacent road segments included in the k-th potential traveling path. By way of example, as shown in FIG. 5, if potential traveling path 1 is 1→2→5→9→11→14, a corresponding p₁ may be expressed as p₁=a₁₋₂·a₂₋₅·a₅₋₉·a₉₋₁₁·a₁₁₋₁₄.

In some embodiments of the present disclosure, by determining potential traveling paths based on the road transition rate matrix and calibrating real-time motion data based on historical average speeds, prediction accuracy can be effectively ensured while computational complexity is significantly reduced, thereby satisfying real-time response performance requirements of the system.

In some embodiments of the present disclosure, by deploying sensing devices in a distance-based hierarchical manner, a layered data acquisition architecture is established, enabling multi-dimensional perception of operating states of risk vehicles and providing a rich data foundation for prediction tasks. Further, through a fusion analysis of the road transition rate matrix and the motion data sequence, the system is capable of simultaneously considering microscopic behaviors of individual risk vehicles and macroscopic statistical characteristics of the road network, such that prediction of the estimated arrival time becomes more scientific and accurate. This hierarchical sensing and fusion-based prediction mechanism not only enhances early identification of potential risks, but also gains valuable time for subsequent emergency responses, thereby significantly improving proactive protection capabilities for height- and load-restricted road segments.

In some embodiments, the emergency supervision management platform is further configured to: determine, based on the motion data sequence, a farthest reachable point of the risk vehicle within a preset time period; determine traffic signal lights to be controlled based on the farthest reachable point and the target road segment; generate a second control parameter within the preset time period, the second control parameter including a common cycle duration and a phase difference corresponding to the traffic signal lights to be controlled; and, within the preset time period, send a second control instruction to the traffic signal lights to be controlled based on the second control parameter. The emergency supervision management platform is further configured to: control, based on the second control instruction, the traffic signal lights to be controlled to configure a master clock timer based on the common cycle duration, trigger a plurality of sub-clocks in synchronization with the master clock timer, each sub-clock being triggered with a delay determined based on a corresponding phase difference, and control at least one relay group to switch on a corresponding second lamp bead unit of each of the traffic signal lights to be controlled so as to drive the second lamp bead unit to emit light.

The farthest reachable point of the risk vehicle within the preset time period refers to a farthest position that the risk vehicle is capable of reaching within the preset time period based on a current motion state of the risk vehicle.

The preset time period refers to a preconfigured future time range, for example, the next 5 minutes, the next 10 minutes, or another time interval. In some embodiments, under an assumption that a safe vehicle encounters green lights throughout its travel from a current position to the target road segment, a time required for the safe vehicle to travel from the current position to the target road segment may be calculated based on a motion data sequence of the safe vehicle, and the calculated time is determined as the preset time period. The safe vehicle refers to a most recently identified vehicle that does not exhibit an over-height or over-load condition prior to identification of the risk vehicle.

In some embodiments, the emergency supervision management platform may determine, based on the motion data sequence, a farthest traveling distance of the risk vehicle from a current position within the preset time period through kinematic estimation, and determine the farthest reachable point according to the farthest traveling distance, a road network structure, the current position of the risk vehicle, and a traveling direction of the risk vehicle. By way of example, the farthest traveling distance may be determined according to Equation (4):

$${P}_{max} = {V}_{current} \cdot t , \qquad ( 4 )$$

wherein, Pₘₐₓ represents the farthest traveling distance; V_{current} represents speed data in the motion data sequence; and t represents the preset time period.

The traffic signal lights to be controlled refer to traffic lights that need to be intervened and regulated in response to an approaching risk vehicle. In some embodiments, by querying road network information, all traffic signal lights located between the farthest reachable point and the target road segment may be determined as the traffic signal lights to be controlled. The second control parameter refers to one or more parameters used to regulate display states of the traffic signal lights to be controlled. In some embodiments, the second control parameter includes a common cycle duration and a phase difference corresponding to the traffic signal lights to be controlled.

A cycle duration refers to a time required for a traffic signal light to complete one full cycle. One full cycle refers to a process in which the traffic signal light starts from an initial phase, sequentially experiences all phases (such as green, yellow, and red), and finally returns to the initial phase. In some embodiments, the common cycle duration of the traffic signal lights may be determined by modeling and solving, using a linear programming technique, based on traffic parameters including traffic flow volumes of approach lanes at intersections where the traffic signal lights are located, counts of lanes, pedestrian crossing times, or the like.

In some embodiments, the common cycle duration may be a maximum time required for completing one full cycle among all the traffic signal lights to be controlled.

A phase difference refers to a difference between start times of green lights of traffic signal lights to be controlled at adjacent intersections. In some embodiments, the phase difference may be determined according to a distance between the adjacent intersections and a preset speed. For example, the phase difference may be determined according to Equation (5):

$$Δ t = \frac{D}{v} , \qquad ( 5 )$$

wherein, Δt represents the phase difference; D represents the distance between adjacent intersections; and v represents the preset speed.

The preset speed refers to a vehicle traveling speed preset manually.

By way of example, if a common cycle duration of the traffic signal lights to be controlled is 50 s, a distance between adjacent intersection A and intersection B is 600 m, and a preset speed is 10 m/s, a theoretical phase difference obtained according to Equation (5) is 60 s. Since the value is greater than the common cycle duration, according to a cyclic characteristic of a signal cycle, the phase difference is converted into an effective phase difference as: 60 s−50 s=10 s. That is to say, when a green-light start time of a traffic signal light to be controlled at intersection B is 10 s later than a green-light start time of a traffic signal lights to be controlled at intersection A, a vehicle passing through intersection A at the green-light start time can still pass through intersection B during a green light when traveling at the preset speed.

The second control instruction is an instruction used to drive the traffic signal lights to be controlled to perform regulation operations. For example, the second control instruction may be: “cycle duration 120 seconds, phase difference 30 seconds.” In some embodiments, the second control instruction is transmitted to the traffic signal lights to be controlled via wired or wireless communication.

In some embodiments, after receiving the second control instruction, the traffic signal lights to be controlled set a main clock timer according to the common cycle duration, trigger a plurality of sub-clocks in synchronization with the master clock timer, each sub-clock being triggered with a delay determined based on a corresponding phase difference, and control at least one relay group to switch on a corresponding second lamp bead unit of each of the traffic signal lights to be controlled so as to drive the second lamp bead unit to emit light.

The main clock timer refers to a module in the traffic signal lights to be controlled that is configured to generate a reference timing signal. In some embodiments, the main clock timer uses the common cycle duration as a timing reference and cyclically generates periodic timing signals, providing a unified time reference for phase switching of the traffic signal lights to be controlled.

The second lamp bead unit refers to an independent lighting component in the traffic signal light to be controlled that is controlled by the relay group and used to implement a traffic indication function. In some embodiments, the second lamp bead unit may be composed of a plurality of green light-emitting diodes.

Merely by way of example, the second control instruction may control a second phase of a traffic signal light to be controlled, wherein the second phase controls the traffic signal light to be controlled to trigger a sub-clock at a green-light start time and cyclically controls the relay group to conduct a green-light phase. The second control instruction may be used to facilitate passage of safe vehicles toward the target road segment.

In some embodiments of the present disclosure, by calculating the farthest reachable point and determining the traffic signal lights to be controlled based on the farthest reachable point and target road segment information, and further precisely controlling switching of the traffic signal lights to be controlled to green based on the common cycle duration and the phase differences, safe vehicles ahead are accelerated to be cleared, thereby forming a dynamic safety buffer zone. This not only effectively reduces rear-end collision risks, but also provides sufficient buffering space for following risk vehicles, reflecting a control concept that combines proactive traffic guidance with safety protection. A closed-loop proactive protection from state perception, behavior prediction, to signal execution is thus achieved, improving emergency control capability for height- and load-restricted road segments and enhancing overall traffic safety.

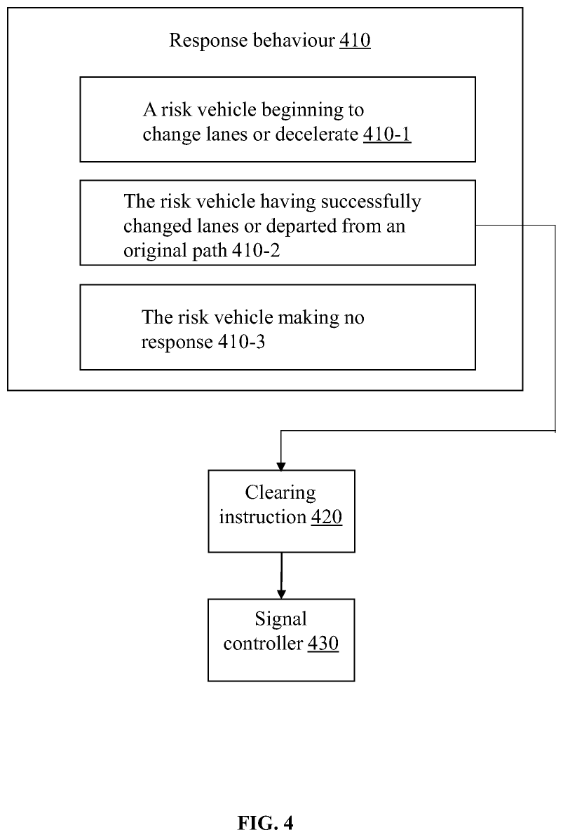

FIG. 4 is an exemplary schematic diagram illustrating response behavior monitoring according to some embodiments of the present disclosure.

In some embodiments, the emergency supervision management platform may monitor a response behavior 410 of a risk vehicle to traffic signal light control. The response behavior 410 includes at least one of: the risk vehicle beginning to change lanes or decelerate 410-1, the risk vehicle having successfully changed lanes or departed from an original path 410-2, and the risk vehicle making no response 410-3. In response to a determination that the risk vehicle has successfully changed lanes or departed from the original path 410-2, a clearing instruction 420 is sent to a signal controller 430 of a target traffic signal light, such that the target traffic signal light is restored to default timing control parameters.

For more details regarding the risk vehicle, traffic signal light control, and the target traffic signal light, reference may be made to FIG. 2 and the related descriptions thereof.

The response behavior refers to a series of specific driving actions taken or states (such as changing lanes or decelerating) exhibited by the risk vehicle after receiving special instructions issued by the emergency supervision management platform via the target traffic signal light.

In some embodiments, the response behavior may include at least one of: the risk vehicle beginning to change lanes or decelerate, the risk vehicle making no response (i.e., the risk vehicle continues traveling at an original speed along the original path), and the risk vehicle having successfully changed lanes or departed from the original path.

In some embodiments, the emergency supervision management platform may determine the response behavior of the risk vehicle in various ways. For example, the emergency supervision management platform may determine the response behavior of the risk vehicle based on a traveling state (e.g., a vehicle speed, a current lane, etc.) of the risk vehicle acquired by roadside radar and intelligent cameras.

In some embodiments, the emergency supervision management platform may be configured to: configured to: obtain a vehicle speed, brake light data, wheel steering angle data, and lane line deviation data of the risk vehicle; in response to a wheel steering angle in the wheel steering angle data being greater than a steering threshold or the brake light data indicating that a brake light is illuminated, determine the response behavior as beginning to change lanes or decelerate; and in response to a speed fluctuation of the risk vehicle being less than a fluctuation threshold and the lane line deviation data satisfying a no-deviation condition, determine the response behavior as making no response.

The vehicle speed of the risk vehicle refers to a real-time traveling speed of the risk vehicle. In some embodiments, the emergency supervision management platform may obtain and record the real-time traveling speed of the risk vehicle based on intelligent cameras, roadside radar, and GPS positioning.

The brake light data refers to a brake light status of the risk vehicle, which can reflect a braking behavior of the risk vehicle. For example, the brake light may be in an illuminated state or a non-illuminated state. In some embodiments, the emergency supervision management platform may acquire the brake light data based on an intelligent camera, thereby determining the braking behavior of the risk vehicle.

The wheel steering angle data refers to real-time information indicating an angle and a direction by which a vehicle steering wheel (typically a front wheel) of the risk vehicle is deflected relative to a longitudinal axis of the vehicle. In some embodiments, the emergency supervision management platform may obtain the wheel steering angle data based on an intelligent camera and roadside radar.

The lane line deviation data refers to real-time information that quantifies a relative relationship between a current position of the vehicle and a reference line of a lane in which the vehicle is traveling. In some embodiments, the lane line deviation data may include a lateral displacement deviation.

The lateral displacement deviation refers to a perpendicular distance from a vehicle center point of the risk vehicle to a lane centerline of the lane in which the risk vehicle is located.

In some embodiments, the emergency supervision management platform may identify left and right lane lines of the lane in which the risk vehicle is located based on an intelligent camera, and calculate the lane centerline. In some embodiments, the emergency supervision management platform may further determine a specific position of the risk vehicle based on an intelligent camera, roadside radar, and an onboard vision system, to obtain the vehicle center point of the risk vehicle, and then calculate the lateral displacement deviation.

In some embodiments, the lateral displacement deviation may be represented as a signed value, with units typically being meters (m) or centimeters (cm). For example, if the vehicle center point of the risk vehicle is located 40 cm to a left side of the lane centerline of the lane in which the risk vehicle is located, the lateral displacement deviation is represented as −40 cm. As another example, if the vehicle center point of the risk vehicle is located 0.5 m to a right side of the lane centerline of the lane in which the risk vehicle is located, the lateral displacement deviation is represented as 0.5 m. As yet another example, if the vehicle center point of the risk vehicle is located on the lane centerline, the lateral displacement deviation is represented as 0.

In some embodiments, if the emergency supervision management platform identifies that the brake light in the brake light data is in an illuminated state, it is determined that the risk vehicle has started decelerating; and if a deflection angle of the vehicle steering wheel relative to the longitudinal axis of the vehicle in the wheel steering angle data exceeds the steering threshold, it is determined that the risk vehicle has started changing lanes.

In some embodiments, the emergency supervision management platform may determine the steering threshold in various manners. For example, the steering threshold may be preset by technical personnel based on prior experience.

In some embodiments, the steering threshold is related to a lane traffic flow and/or a lane width of the lane in which the risk vehicle is located.

In some embodiments, the steering threshold may be positively correlated with the lane traffic flow and negatively correlated with the lane width.

The lane traffic flow refers to a real-time traffic volume of the lane in which the risk vehicle is located, and may be acquired by an intelligent camera or roadside radar.

The lane width refers to a width of the lane in which the risk vehicle is located, and may be acquired by an intelligent camera, roadside radar, and an onboard vision system, or may alternatively be obtained by directly querying historical statistical data from relevant websites.

In some embodiments of the present disclosure, the steering threshold is related to the lane width and the lane traffic flow. For example, when a narrow lane has a high traffic flow, automatically reducing the steering threshold for lane-change determination can improve risk sensitivity of the IoT system for smart city overheight and overload emergency early warning.

In some embodiments, if the emergency supervision management platform identifies that a speed fluctuation of the risk vehicle is less than a fluctuation threshold and the lane line deviation data satisfies a non-deviation condition, it is determined that the risk vehicle has not made a response.

The speed fluctuation of the risk vehicle refers to a variance and/or a mean value of an absolute value of speed changes of the risk vehicle within a preset time period.

In some embodiments, the emergency supervision management platform may determine the fluctuation threshold based on historical data. The fluctuation threshold may be obtained from a variance and/or a mean value of absolute values of speed changes of all risk vehicles that did not make a response in the road network, within historical time periods corresponding to the preset time period as recorded in the historical data.

The non-deviation condition refers to a distance threshold. If, within the preset time period, the lateral displacement deviation of the risk vehicle is always less than the distance threshold, it is determined that the risk vehicle satisfies the non-deviation condition. The distance threshold may be preset by technical personnel based on prior experience, for example, 0.3 meters.

For more details regarding the preset time period, reference may be made to FIG. 3 and the related descriptions thereof.

In some embodiments of the present disclosure, by performing analytical determination through fusion of multi-source data such as vehicle speed, brake light status, steering angle, and lane deviation, rather than relying on a single indicator, a multi-dimensional and highly reliable vehicle behavior recognition solution is provided, which significantly improves accuracy and fault tolerance in determining response behaviors of risk vehicles and reduces a misjudgment rate.

In some embodiments, the emergency supervision management platform may obtain continuous positioning data of the risk vehicle via roadside radar and/or an intelligent camera. If, based on the continuous positioning data, it is determined that the risk vehicle has entered an adjacent lane not leading to the target road section or another branch road, it is determined that the risk vehicle has successfully changed lanes or departed from the original path.

For more details regarding the target road section, reference may be made to FIG. 3 and the related descriptions thereof.

The signal controller refers to a device that automatically controls color states (red, yellow, and green) of traffic signal lights and switching timing of the traffic signal lights according to a preset scheme or an external instruction.

The clearing instruction refers to a control instruction having a highest priority, which is capable of controlling the signal controller to terminate a currently executed instruction (e.g., the first control instruction or the second control instruction) and immediately restore the default timing control parameters.

In some embodiments, in response to the risk vehicle having successfully changed lanes or departed from the original path, the emergency supervision management platform may further transmit the clearing instruction to the signal controller of the traffic signal lights to be controlled, so as to cause the traffic signal lights to be controlled to restore the default timing control parameters.

For more details regarding the traffic signal lights to be controlled, reference may be made to FIG. 3 and the related descriptions thereof.

The default timing control parameters refer to a set of basic time values that are preset and stored in the signal controller, and are used to define basic timing rules for periodic and fixed-order switching of light colors of traffic signal lights at an intersection or within a signal control region.

In some embodiments of the present disclosure, once the system monitors that the risk vehicle has been successfully guided or has departed, all special signal control is immediately released, so that traffic signal lights are rapidly restored to normal operation, thereby minimizing adverse impacts on traffic efficiency of other normal vehicles. This reflects a human-centered design concept and a principle of efficiency maximization. Meanwhile, by monitoring response behaviors of risk vehicles, agility and intelligence of the IoT system for smart city overheight and overload emergency early warning are enhanced, and a complete closed loop from “control initiation” to “control termination” is achieved, enabling the IoT system to flexibly cope with dynamically changing traffic scenarios rather than rigidly executing preset instructions.

In some embodiments, the present disclosure further includes a non-transitory computer-readable storage medium. The storage medium stores computer instructions, and when a computer reads the computer instructions stored in the storage medium, the computer executes the method for smart city height- and load-restriction emergency early-warning described in one or more embodiments of the present disclosure.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

Meanwhile, the present disclosure uses specific terms to describe the embodiments herein. Terms such as “one embodiment,” “an embodiment,” and/or “some embodiments” mean that a certain feature, structure, or characteristic related to at least one embodiment of the present disclosure. Therefore, it is emphasized and noted that the terms “an embodiment,” “one embodiment,” or “an alternative embodiment” mentioned two or more times at different locations in the present disclosure do not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers or letters, or the use of other names in the present disclosure is not intended to limit the order of the processes and methods described herein. Although the foregoing disclosure discusses some currently considered useful inventive embodiments through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the system components described above may be implemented via hardware devices, they may also be realized solely through software solutions, such as installing the described system on existing servers or mobile devices.

Similarly, it should be noted that to simplify the presentation of the present disclosure and thereby aid in understanding one or more inventive embodiments, in the descriptions of the embodiments of the present disclosure above, various features may sometimes be grouped into a single embodiment, figure, or description thereof. However, this disclosure manner does not imply that the subject matter of the present disclosure requires more features than those mentioned in the claims. In fact, the features of an embodiment are fewer than all the features of a single embodiment disclosed above.

In some embodiments, numbers describing quantities or attributes are used. It should be understood that such numbers used in the description of the embodiments may, in some examples, be modified by the terms “approximately,” “about,” or “substantially.” Unless otherwise specified, “approximately,” “about,” or “substantially” indicates that the stated number allows for a variation of ±20%. Accordingly, in some embodiments, the numerical parameters used in the specification and claims are approximations, which may vary depending on the characteristics required by individual embodiments. In some embodiments, numerical parameters should consider the specified number of significant digits and adopt the method of general digit retention. Although the numerical ranges and parameters used to confirm their breadth in some embodiments of the present disclosure are approximations, in specific embodiments, such numerical values are set as accurately as possible within the feasible range.

For each patent, patent application, patent application publication, and other material, such as articles, books, specifications, publications, documents, etc., cited in the present disclosure, the entire content thereof is hereby incorporated by reference into the present disclosure. Excluded are application history documents that are inconsistent or conflict with the content of the present disclosure, and documents that limit the broadest scope of the claims of the present disclosure (whether currently or subsequently appended to the present disclosure). It should be noted that if the description, definition, and/or use of terms in the supplementary materials of the present disclosure are inconsistent or conflict with those in the present disclosure, the description, definition, and/or use of terms in the present disclosure shall prevail.

Finally, it should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. An Internet of Things (IoT) system for smart city overheight and overload emergency early warning, comprising an emergency supervision management platform, wherein the emergency supervision management platform is configured to:
obtain vehicle sensing data of an upstream road section of a target road section, the target road section being an overheight and overloaded road section;
determine a risk vehicle based on the vehicle sensing data; and
in response to an estimated arrival time of the risk vehicle at the target road section satisfying a preset condition, perform traffic signal light control, wherein to perform the traffic signal light control, the emergency supervision management platform is further configured to:
predict a time at which the risk vehicle arrives at a target traffic signal light;
determine a first control parameter based on the time at which the risk vehicle arrives at the target traffic signal light, wherein the first control parameter includes a start time at which the target traffic signal light is switched to a target state;
send a first control instruction to the target traffic signal light based on the first control parameter; and
control, based on the first control instruction, the target traffic signal light to trigger a sub-clock at the start time, and control a relay group to conduct a first lamp bead unit, so as to drive the first lamp bead unit to emit light.

2. The IoT system of claim 1, wherein the first control parameter further includes a duration of the target state, and the emergency supervision management platform is further configured to:
determine a target dwell time of the risk vehicle at the target traffic signal light; and
determine the first control parameter based on the time at which the risk vehicle arrives at the target traffic signal light and the target dwell time.

3. The IoT system of claim 2, wherein the emergency supervision management platform is further configured to:
determine a target time period based on a time point at which the risk vehicle is determined; and
determine the target dwell time based on an accumulated travel distance of the risk vehicle traveling along an original planned route and a speed sequence of the risk vehicle within the target time period.

4. The IoT system of claim 1, wherein the emergency supervision management platform is further configured to:
obtain motion sensing data from multi-level sensing devices, wherein levels of the multi-level sensing devices are classified based on distances between the multi-level sensing devices and the risk vehicle;
construct a motion data sequence of the risk vehicle based on the motion sensing data; and
determine the estimated arrival time based on a road transition rate matrix and the motion data sequence.

5. The IoT system of claim 4, wherein the emergency supervision management platform is further configured to:
determine one or more potential travel paths based on the road transition rate matrix;
determine one or more historical average speeds corresponding to the potential travel paths; and
determine the estimated arrival time based on the motion data sequence and the one or more historical average speeds.

6. The IoT system of claim 4, wherein the emergency supervision management platform is further configured to:
determine, based on the motion data sequence, a farthest reachable point of the risk vehicle within a preset time period;
determine traffic signal lights to be controlled based on the farthest reachable point and the target road section;
generate a second control parameter within the preset time period, wherein the second control parameter includes a common cycle duration shared by the traffic signal lights to be controlled and respective phase differences of the traffic signal lights to be controlled;
within the preset time period, send a second control instruction to the traffic signal lights to be controlled based on the second control parameter; and
control, based on the second control instruction, the traffic signal lights to be controlled to configure a master clock timer based on the common cycle duration, trigger a plurality of sub-clocks in synchronization with the master clock timer, each sub-clock being triggered with a delay determined based on a corresponding phase difference, and control at least one relay group to switch on a corresponding second lamp bead unit of each of the traffic signal lights to be controlled so as to drive the second lamp bead unit to emit light.

7. The IoT system of claim 1, wherein the emergency supervision management platform is further configured to:
monitor a response behavior of the risk vehicle to the traffic signal light control, wherein the response behavior includes at least one of: the risk vehicle beginning to change lanes or decelerate, the risk vehicle making no response, and the risk vehicle having successfully changed lanes or departed from an original path; and
in response to the risk vehicle having successfully changed lanes or departed from the original path, send a clearing instruction to a signal controller of the target traffic signal light, so as to cause the target traffic signal light to restore default timing control parameters.

8. The IoT system of claim 7, wherein the emergency supervision management platform is further configured to:
obtain a vehicle speed, brake light data, wheel steering angle data, and lane line deviation data of the risk vehicle;
in response to a wheel steering angle in the wheel steering angle data being greater than a steering threshold or the brake light data indicating that a brake light is illuminated, determine the response behavior as beginning to change lanes or decelerate; and
in response to a speed fluctuation of the risk vehicle being less than a fluctuation threshold and the lane line deviation data satisfying a no-deviation condition, determine the response behavior as making no response.

9. The IoT system of claim 8, wherein the steering threshold is related to a lane traffic flow and/or a lane width of a lane in which the risk vehicle is located.

10. A method for smart city overheight and overload emergency early warning, being implemented by an emergency supervision management platform, the method comprising:
obtaining vehicle sensing data of an upstream road section of a target road section, the target road section being an overheight and overloaded road section;
determining a risk vehicle based on the vehicle sensing data; and
in response to an estimated arrival time of the risk vehicle at the target road section satisfying a preset condition, performing traffic signal light control, including:
predicting a time at which the risk vehicle arrives at a target traffic signal light;
determining a first control parameter based on the time at which the risk vehicle arrives at the target traffic signal light, wherein the first control parameter includes a start time at which the target traffic signal light is switched to a target state;
sending a first control instruction to the target traffic signal light based on the first control parameter; and
controlling, based on the first control instruction, the target traffic signal light to trigger a sub-clock at the start time, and controlling a relay group to switch on a first lamp bead unit, so as to drive the first lamp bead unit to emit light.

11. The method of claim 10, wherein the first control parameter further includes a duration of the target state, and the determining a first control parameter based on the time at which the risk vehicle arrives at the target traffic signal light includes:
determining a target dwell time of the risk vehicle at the target traffic signal light; and
determining the first control parameter based on the time at which the risk vehicle arrives at the target traffic signal light and the target dwell time.

12. The method of claim 11, wherein the determining a target dwell time of the risk vehicle at the target traffic signal light includes:
determining a target time period based on a time point at which the risk vehicle is determined; and
determining the target dwell time based on an accumulated travel distance of the risk vehicle traveling along an original planned route and a speed sequence of the risk vehicle within the target time period.

13. The method of claim 10, further comprising:
obtaining motion sensing data from multi-level sensing devices, wherein levels of the multi-level sensing devices are classified based on distances between the multi-level sensing devices and the risk vehicle;
constructing a motion data sequence of the risk vehicle based on the motion sensing data; and
determining the estimated arrival time based on a road transition rate matrix and the motion data sequence.

14. The method of claim 13, wherein the determining the estimated arrival time based on a road transition rate matrix and the motion data sequence includes:
determining one or more potential travel paths based on the road transition rate matrix;
determining one or more historical average speeds corresponding to the potential travel paths; and
determining the estimated arrival time based on the motion data sequence and the one or more historical average speeds.

15. The method of claim 13, further comprising:
determining, based on the motion data sequence, a farthest reachable point of the risk vehicle within a preset time period;
determining traffic signal lights to be controlled based on the farthest reachable point and the target road section;
generating a second control parameter within the preset time period, wherein the second control parameter includes a common cycle duration shared by the traffic signal lights to be controlled and respective phase differences of the traffic signal lights to be controlled;
within the preset time period, sending a second control instruction to the traffic signal lights to be controlled based on the second control parameter; and
controlling, based on the second control instruction, the traffic signal lights to be controlled to configure a master clock timer based on the common cycle duration, triggering a plurality of sub-clocks in synchronization with the master clock timer, each sub-clock being triggered with a delay determined based on a corresponding phase difference, and controlling at least one relay group to switch on a corresponding second lamp bead unit of each of the traffic signal lights to be controlled so as to drive the second lamp bead unit to emit light.

16. The method of claim 10, further comprising:
monitoring a response behavior of the risk vehicle to the traffic signal light control, wherein the response behavior includes at least one of: the risk vehicle beginning to change lanes or decelerate, the risk vehicle making no response, and the risk vehicle having successfully changed lanes or departed from an original path; and
in response to the risk vehicle having successfully changed lanes or departed from the original path, sending a clearing instruction to a signal controller of the target traffic signal light, so as to cause the target traffic signal light to restore default timing control parameters.

17. The method of claim 16, wherein the monitoring a response behavior of the risk vehicle to the traffic signal light control includes:
obtaining a vehicle speed, brake light data, wheel steering angle data, and lane line deviation data of the risk vehicle;
in response to a wheel steering angle in the wheel steering angle data being greater than a steering threshold or the brake light data indicating that a brake light is illuminated, determining the response behavior as beginning to change lanes or decelerate; and
in response to a speed fluctuation of the risk vehicle being less than a fluctuation threshold and the lane line deviation data satisfying a no-deviation condition, determining the response behavior as making no response.

18. The method of claim 17, wherein the steering threshold is related to a lane traffic flow and/or a lane width of a lane in which the risk vehicle is located.

19. A non-transitory computer-readable storage medium, storing computer instructions, wherein when reading the computer instructions in the storage medium, a computer executes a method for smart city overheight and overload emergency early warning, the method comprising:
obtaining vehicle sensing data of an upstream road section of a target road section, the target road section being an overheight and overloaded road section;
determining a risk vehicle based on the vehicle sensing data; and
in response to an estimated arrival time of the risk vehicle at the target road section satisfying a preset condition, performing traffic signal light control, including:
predicting a time at which the risk vehicle arrives at a target traffic signal light;
determining a first control parameter based on the time at which the risk vehicle arrives at the target traffic signal light, wherein the first control parameter includes a start time at which the target traffic signal light is switched to a target state;
sending a first control instruction to the target traffic signal light based on the first control parameter; and
controlling, based on the first control instruction, the target traffic signal light to trigger a sub-clock at the start time, and controlling a relay group to conduct a first lamp bead unit, so as to drive the first lamp bead unit to emit light.
